(19) United States
(12) Patent Application Publication
(10) Pub. No.: US 2025/0180391 A1
(43) Pub. Date: Jun. 5, 2025

(54) FILL LEVEL MEASURING SYSTEM AND METHOD

(71) Applicant: SKF Lubrication Systems Germany GmbH, Walldorf (DE)

(72) Inventors: Joerg SCHWARTZ, Potsdam (DE); Antonio Almeida MANHICA, Berlin (DE)

(21) Appl. No.: 18/842,698

(22) PCT Filed: Feb. 22, 2023
(86) PCT No.: PCT/EP2023/054410

§ 371 Date: Aug. 29, 2024

(30) Foreign Application Priority Data
Mar. 2, 2022 (DE) 10 2022 202 133.9

(51) Int. Cl. G01F 23/28

(52) U.S. Cl. CPC G01F 23/28

(57) ABSTRACT

A fill level measuring system (1) for measuring the fill level in a reservoir. The system (1) includes a sensor element (8) arranged relative to a surface (2) of a substance in the reservoir. The sensor element (8) transmits a measuring signal in the direction of the surface (2) and receives a reflection signal reflected from the surface (2) in response to the measuring signal. A processing unit (14), based on the time difference between the transmitting of the measuring signal and the receiving of the reflection signal, carries out a travel time measurement and processes measurement values of the travel time measurement, in order to determine a fill level of the reservoir. The processing unit (14) detects disturbances on the surface (2) and takes the disturbances into account when determining the fill level.

### CROSS-REFERENCE TO RELATED APPLICATIONS

This application claims priority to and is a 371 National Stage of PCT Application No. PCT/EP2023/054410, filed Feb. 22, 2023, which claims priority to German Application No. 102022202133.9, filed Mar. 2, 2022, the entireties of which are hereby incorporated by reference.

### FIELD

The present disclosure relates to a fill level measuring system for measuring the fill level in a reservoir, according to the preamble of claim 1. The present disclosure also relates to a method for measuring the fill level in a reservoir, according to the preamble of claim 9.

### BACKGROUND

Reservoirs can be used to store a fluid or any other substance and are usually connected to lines in order to transfer the content of the reservoir to other apparatuses or equipment. The reservoir may, for example, be a lubricant reservoir in which oil or grease is stored, with the lubricant being dispensed to lubrication systems for bearings or similar. It is often necessary to monitor the fill height of the reservoir. The fill level of the reservoir can be monitored by various monitoring apparatuses, for example a floating sensor or capacitive sensors. For example, floating sensors offer a cost-effective and accurate determination of the fill height for as long as there is no movement in the content of the reservoir which leads to a surface movement.

However, accurate information can no longer be obtained by way of a conventional floating sensor as soon as the surface of the substance stored in the reservoir is subject to disturbances, for example as is the case if the content of the reservoir is stirred by means of agitator blades or put into motion by vibrations and/or movements of the reservoir. Such a floating sensor would move together with the surface, which forms peaks and troughs on account of the movement, and would therefore lead to higher or lower fill levels than the actual fill level. The use of other known sensors, e.g. acoustic sensors, would also lead to incorrect fill level information in the case of such disturbances.

Thus the problem addressed by the present disclosure is that of providing a system and method for determining the fill level in a reservoir which enables an accurate measurement of the fill level even in the case of an irregular reservoir content surface.

### SUMMARY

This problem is solved by a fill level measuring system for measuring the fill level in a reservoir as claimed in claim 1 and by a method for measuring the fill level in a reservoir as claimed in claim 9.

The fill level measuring system for measuring the fill level in a reservoir comprises a sensor element arranged relative to a surface of a substance present in the reservoir and configured to transmit a measurement signal in the direction of the surface and receive a reflection signal reflected by the surface in response to the measurement signal. The sensor element can be any type of optical sensor element, for example an ultrasound sensor, infrared sensor or the like. In any case, the sensor element is suitable for transmitting a signal in the direction of the surface, with the signal being reflected by the surface. The reflection signal is then received by the sensor element again, and the time interval between transmission and reception of the signal is subsequently used by a processing unit of the fill level measuring system to conduct a time-of-flight measurement on the basis of this time difference. The processing unit is also configured to process the measurement values from the time-of-flight measurement in order to determine a fill height of the reservoir. The longer the time of flight, the lower the fill level of the reservoir.

In contrast with previous systems, in order now to be able to determine the fill height independently of surface irregularities as may arise for example due to the reservoir content being stirred, the processing unit is configured to detect such disturbances on the surface and take these into account when determining the fill height. This allows the data obtained by the time-of-flight measurement to be corrected accordingly when disturbances are detected, and the fill height determination for the reservoir is thus improved.

According to an embodiment, the processing unit is configured to form a moving average from the measurement values from the time-of-flight measurement. When forming a moving average, a new mean value is calculated continually on the basis of new measurement values from the time-of-flight measurement. For example, this can be implemented according to the following formula:

$${GMW}_{new} = {GMW}_{old} minus {GMW}_{old} / D + NW / D$$

where GMW is the moving average, NW is the new value, i.e. the current value of the time-of-flight measurement, and D is the number of values used for the moving average. In this case, D should be at least greater than or equal to 1. The greater D is chosen to be, the slower the moving average changes, whereby the damping in the calculation becomes larger. Larger damping means that changes in the fill level become noticeable more slowly. The current moving average of the measurement values can be defined as the current fill height.

If the content of a reservoir is successively let out or filled or if the reservoir or the reservoir content is moved, then the surface of the substance present in the reservoir, and hence the fill height, is subjected firstly to continual changes and secondly to disturbances, which is why the measurement values from the time-of-flight measurement do not always correspond to the fill level. For example, the grease surface in a grease reservoir with agitator blades frequently forms peaks and troughs which move and change during operation. Wave-like surface movements can also arise in reservoirs of oil circulation assemblies. The fill level measuring system described herein makes it possible to detect such surface movements and take these into account when determining the fill height.

According to a further embodiment, the processing unit is configured to compare a current measurement value with the moving average and classify the current measurement value as erroneous if the current measurement value deviates from the moving average by more than a predefined threshold value. This means that the processing unit can analyze current measurement values and classify these as disturbances or outliers. If current measurement values are identified as disturbances, they are subsequently no longer taken into account when forming the moving average so that a high measurement accuracy is obtained. Since the current measurement values are compared with a threshold value, relatively small deviations which would not falsify the moving average can be ignored, and only large deviations which would falsify the overall result of the fill height determination more than proportionally are specified as disturbances and ignored when forming the moving average. The threshold value can be chosen depending on the actual application, for example depending on the reservoir content.

Surface movements may occur cyclically, especially if an agitator is used in the reservoir. Thus, according to a further embodiment, the processing unit can be configured to determine whether the measurement value classified as erroneous occurs cyclically. Such a cyclical occurrence of the measurement value classified as erroneous is then defined as a cyclical disturbance by the processing unit and not included in the averaging. For example, such cyclical disturbances indicate that the disturbance is caused on account of agitator blades of an assembly and therefore not related to the actual fill height.

According to a further embodiment, the processing unit is configured to output a warning signal if the determined fill height of the reservoir drops below a predefined lower limit. For example, a pre-warning can be output at a fill height of 20% and a warning can be output at a fill height of 10%, in order to prompt filling of the reservoir. Other limits and other types of warning signals are also possible.

As mentioned previously, the substance in the reservoir can be a grease. Other types of substances, such as fluids or solids, e.g. a granulate, which can be stored in a reservoir are also possible.

According to a further aspect, a method for measuring the fill level in a reservoir is proposed, wherein the method includes the following steps: transmitting a measurement signal in the direction of a surface of a substance present in the reservoir, receiving a reflection signal reflected by the surface in response to the measurement signal, conducting a time-of-flight measurement on the basis of the time difference between measurement signal transmission and reflection signal reception and processing measurement values from the time-of-flight measurement in order to determine a fill height of the reservoir. The method moreover comprises: detecting disturbances on the surface and taking account of the disturbances when determining the fill height.

The advantages and embodiments described above in relation to the fill level measuring system apply accordingly to the method for measuring the fill level in a reservoir, and vice versa.

Furthermore, a computer program product is proposed, the latter including program code designed to prompt the execution of the method as explained above on a computer.

A computer program product, e.g. a computer program means, can be provided or supplied for example as a storage medium, e.g. a memory card, USB stick, CD-ROM, DVD, or else in the form of a file downloadable from a server on a network. For example, this can be implemented in a wireless communications network by transferring a corresponding file with the computer program product or the computer program means.

Further advantages and advantageous embodiments are specified in the description, the drawings and the claims. In particular the combinations of the features specified in the description and in the drawings are purely exemplary here, and therefore the features can also be present individually or in other combinations.

### BRIEF DESCRIPTION OF THE DRAWINGS

In the following text, the present disclosure will be described in more detail using exemplary embodiments illustrated in the drawings. The exemplary embodiments and the combinations shown in the exemplary embodiments are purely exemplary here and are not intended to define the scope of protection of the present disclosure. This is defined solely by the attached claims.

In detail:

FIG. 1 shows a schematic sectional view of a fill level measuring system.

In the following text, identical or functionally equivalent elements are identified by the same reference signs.

### DETAILED DESCRIPTION

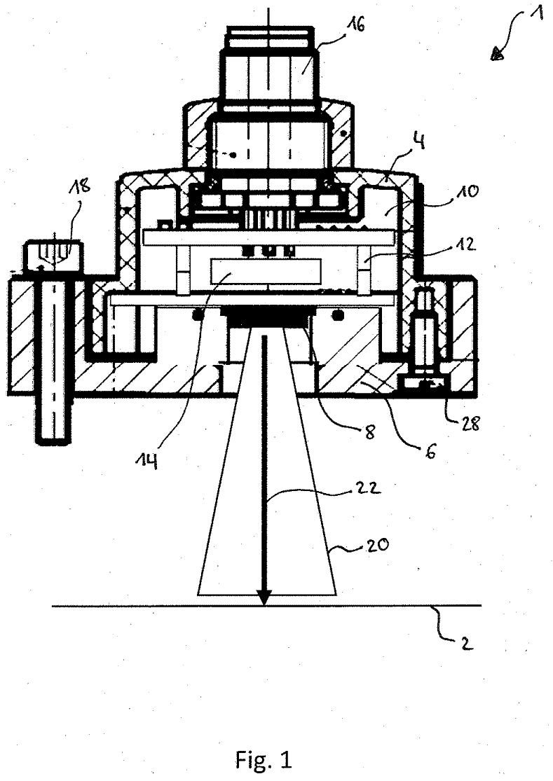

FIG. 1 shows a fill level measuring system 1 designed for measuring a fill height of a substance in a reservoir. The fill level measuring system 1 comprises a sensor housing 4 with a base plate 6, wherein the base plate 6 can be connected to the sensor housing 4 via fastening means 28. By way of its base plate 6, the sensor housing 4 defines an interior 10 in which a sensor element 8 and an evaluation electronic system 12 with a processing unit 14 are arranged. Furthermore, the sensor housing 4 comprises a connection 16, via which the fill level measuring system can be connected to external apparatuses, such as computational apparatuses, etc. The fill level measuring system can be connected to the reservoir (not shown) via fastening means 18.

In order now to measure the fill height 2, the sensor element 8 is configured to transmit a signal which is reflected by a surface 2 of the content of the reservoir and is then received again by the sensor element 8. The sensor element 8 may be designed to transmit and/or receive the signal within a measurement lobe 20. Via the transmitted and reflected signal, the processing unit 14 can then conduct a time-of-flight measurement to determine a distance 22 between the sensor element 8 and the surface 2. For example, the determination of fill height of the reservoir can be implemented by forming a moving average from of the measurement values from the time-of-flight measurement. In this case, the moving average reflects the fill height.

In a reservoir in which, for example, grease is stored, agitator blades may be provided to stir the content of the reservoir. Such processes, or else other processes in the reservoir, for example a movement of the reservoir if this relates to a vehicle tank, may lead to surface disturbances. Such surface disturbances lead to movements of the surface 2 and hence to varying measurement values from the sensor element 8.

To detect such disturbances, which may falsify the determination of the fill height, and exclude them from the fill height determination, the processing unit 14 is configured to detect these disturbances and not take them into account in the averaging. For example, the processing unit 14 can classify a measurement value as erroneous if the latter deviates from the moving average by a predefined threshold value. Such measurement value outliers can be interpreted as a disturbance, and the processing unit 14 then ignores these when calculating the mean value.

Additionally, the processing unit 14 can identify whether these are cyclical disturbances. Cyclical disturbances are frequently caused by agitators or the like in the reservoir and can therefore be interpreted as disturbances not related to the fill height.

The fill level measuring system proposed here thus makes it possible to easily determine a fill height of a reservoir, wherein movements of the content of the reservoir, which might lead to incorrect determinations of the fill height, are detected and taken into account accordingly.

### LIST OF REFERENCE SIGNS

1 Fill level measuring system
2 Surface
4 Sensor housing
6 Base plate
8 Sensor element
10 Inner element
12 Evaluation electronic system
14 Processing unit
16 Connection
18 Fastening means
20 Measurement lobe
22 Distance

1. A fill level measuring system for measuring the fill level in a reservoir, the fill level measuring system comprising:
a sensor element configured to be arranged relative to a surface of a substance present in the reservoir, the sensor element configured to transmit a measurement signal in the direction of the surface and receive a reflection signal reflected by the surface in response to the measurement signal, and
a processing unit configured to conduct a time-of-flight measurement on the basis of the time difference between measurement signal transmission and reflection signal reception, the processing unit being configured to process measurement values from the time-of-flight measurement in order to determine a fill height of the reservoir, the processing unit being configured to detect disturbances on the surface and take the disturbances into account when determining the fill height.

2. The fill level measuring system of claim 1, wherein the processing unit is configured to form a moving average from the measurement values.

3. The fill level measuring system of claim 2, wherein the current moving average of the measurement values is the current fill height.

4. The fill level measuring system of claim 2, wherein the processing unit is configured to compare a current measurement value with the moving average and classify the current measurement value as erroneous if the current measurement value deviates from the moving average by more than a predefined threshold value.

5. The fill level measuring system of claim 4, wherein the processing unit is configured to determine whether the measurement value classified as erroneous occurs cyclically.

6. The fill level measuring system of claim 5, wherein the processing unit is configured to define the erroneous mean value as a cyclical disturbance and not include it in the averaging if it is determined that the measurement value classified as erroneous occurs cyclically.

7. The fill level measuring system of claim 1, wherein the processing unit is configured to output a warning signal if the determined fill height of the reservoir drops below a predefined lower limit.

8. The fill level measuring system of claim 1, wherein the substance in the reservoir is a grease.

9. A method for measuring the fill level in a reservoir, the method comprising:
transmitting a measurement signal in the direction of a surface of a substance present in the reservoir,
receiving a reflection signal reflected by the surface in response to the measurement signal,
conducting a time-of-flight measurement on the basis of the time difference between measurement signal transmission and reflection signal reception, and
processing measurement values from the time-of-flight measurement in order to determine a fill height of the reservoir, and
detecting disturbances on the surface and taking account of the disturbances when determining the fill height.

10. The fill level measuring system of claim 3, wherein the processing unit is configured to compare a current measurement value with the moving average and classify the current measurement value as erroneous if the current measurement value deviates from the moving average by more than a predefined threshold value.

11. The fill level measuring system of claim 10, wherein the processing unit is configured to determine whether the measurement value classified as erroneous occurs cyclically.

12. The fill level measuring system of claim 11, wherein the processing unit is configured to define the erroneous mean value as a cyclical disturbance and not include it in the averaging if it is determined that the measurement value classified as erroneous occurs cyclically.

13. The fill level measuring system of claim 12, wherein the processing unit is configured to output a warning signal if the determined fill height of the reservoir drops below a predefined lower limit.

14. The fill level measuring system of claim 13, wherein the substance in the reservoir is a grease.
